(19) United States
(12) Patent Application Publication
(10) Pub. No.: US 2003/0071429 A1
(43) Pub. Date: Apr. 17, 2003

(54) Transportation apparatus

(76) Inventor: William R. Bradshaw, Oak Lawn, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/230,873

(22) Filed: Aug. 28, 2002

Related U.S. Application Data
(60) Provisional application No. 60/315,396, filed on Aug. 28, 2001.

(51) Int. Cl. B62M 1/00

(52) U.S. Cl. 280/87.041; 280/87.05

(57) ABSTRACT

A wheeled personal transportation device, such as a skateboard or a scooter, that is convertible between a riding configuration and an inclined configuration. In the riding configuration the personal transportation device can roll on a rolling surface via two or more sets of wheels. In the inclined configuration, the personal transportation device can roll on a rolling surface via one of the sets of wheels for transporting either the transportation device itself or the transportation device in combination with lading.

### FIELD

A transportation apparatus, and particularly a transportation apparatus convertible between a riding configuration and an apparatus and/or lading transportation configuration.

### BACKGROUND

Personal, wheeled transportation devices are generally used for both entertainment and as a means of transportation. Such devices may include skateboards, scooters, or other wheeled personal transportation devices that are adapted to permit rolling transport of a rider. For example, a skateboard usually comprises a planar surface having two or more pairs of wheel sets disposed on a first side and a second side for a rider to stand upon. Scooters are generally similar to skateboards, but with the addition of an upright handle. Scooters may also have different wheel configurations as compared to skateboards.

While typically effective as a means of transportation, such devices generally can become cumbersome or burdensome to store or otherwise dispose of when a rider no longer wishes to ride the device, such as when the rider arrives at a destination. In some instances the roads and sidewalks on which the transportation devices travel may become crowded, limiting or preventing the use of the device for continued transportation of a rider.

Rolling carts are often used for the transportation of luggage, packs, or other lading. Such carts often include just one set of wheels positioned at the bottom of the cart, a handle assembly extending upwardly from the wheel set, and a platform or other support surface for the lading extending generally perpendicular to the handle assembly. Although effective for transportation lading, roller carts can be burdensome once they are no longer needed for transporting lading due to their usual single-use purpose.

Furthermore, typical roller carts can be limited in their mobility to being pushed or pulled by the user. Thus, the speed at which a roller cart can transport lading is often limited by the speed at which the user pushes or pulls the cart.

Personal transportation devices, such as skateboards and scooters, may weigh considerable amounts. For example, scooters or skateboards equipped with motors for propelling the devices may weigh considerable amounts. These weights may render it tiresome or otherwise undesirable to carry the skateboard or scooter when it is desired to transport the skateboard or scooter without riding in the usual manner. Often, scooters are provided with carrying slings or bags for allowing the scooter to be carried by a user. It is also known provide backpacks or other devices, such as the carrier case illustrated in U.S. Pat. No. 5,492,254 to Challoner et al., for use in transporting skateboards. However, such packs and other carrying devices do not reduce the weight or other burdens of transporting scooters or skateboards when not riding them.

### SUMMARY

Apparatus are provided that are capable of transporting riders in one aspect, and lading and/or the apparatus itself in another aspect, by converting between a riding configuration and a lading and/or apparatus transporting configuration. The apparatus preferably enables a rider to use the device as a means of personal transportation when in its riding configuration. The apparatus preferably can also be used to effectively transport lading and/or the apparatus itself when in its transporting configuration.

In one aspect, the transportation apparatus generally comprises a skateboard. The skateboard may have a planar surface having a first side and a second side opposite the first side, with two or more wheel sets disposed on the first side of the planar surface. In one arrangement, a first wheel set may be positioned proximate a first end of the planar surface and a second wheel set may be positioned proximate a second end of the planar surface opposite the first end.

The skateboard may have a first or riding configuration, wherein a user may ride on top of the second side of the planar surface and propel the skateboard along a riding surface. In the riding configuration, the planar surface of the skateboard generally is planar to the riding surface and the wheel sets substantially contact the riding surface. The skateboard also may have a second or transporting configuration, wherein the skateboard may be used to transport lading and/or the skateboard itself. In the second configuration, the skateboard may be inclined at a angle relative to a riding surface such that a wheel set at a first or lower end of the planar surface in its inclined position is in contact with the riding surface. In its inclined configuration, lading may be attached to one of the sides of the planar surface. The second end may of the planar surface may be adapted for pulling or pushing by the user to enable the user to push or pull the skateboard in its inclined position, such as with lading attached thereto. Although referred to as an inclined configuration herein, other configurations wherein the apparatus or skateboard is used to transport itself or lading, including but not limited to any position other than the riding position, are contemplated.

In one aspect, a skateboard may be adapted for conversion between a rider transporting configuration and a lading transporting configuration by positioning a rear set of wheels proximate a rearward edge of a planar riding surface. The wheel set may be positioned such that outer diameters of wheels of the wheel set are substantially aligned with the rearward edge of the planar riding surface. By positioning the rear set of wheels proximate the rearward edge of the planar riding surface, the rear wheels may allow for the skateboard to be effectively rolled thereby along a rolling surface without substantial interference between the rearward edge of the planar riding surface and the rolling surface.

According to another aspect, the rear set or sets of wheels may be movable between a riding position and a lading transporting position. In the riding position, the rear set of wheels may be positioned substantially beneath the planar surface of the skateboard to provide a skateboard with riding characteristics generally comparable to typical skateboards. However, the rear set of wheels may be movable from the riding position to the lading transporting position, whereby the wheels at least substantially aligned with the rearward edge of the planar board surface to facilitate rolling of the skateboard on the wheels with reduced or no interference caused by the planar board surface. In one aspect, the rear wheels may at least partially protrude beyond the rearward edge of the skateboard in the lading transporting configuration. By having the rear wheels movable between riding and lading transporting positions, the skateboard can maintain typical skating characteristics when in the riding mode, but allow for easy repositioning to facilitate using the skateboard in its inclined or transporting configuration.

In one aspect, at least one rear set of wheels may be mounted relative to the planar board surface with a hinge or other joint to allow the rear set of wheels to move between a riding position and a lading transporting position. The hinge may comprise a first half pivotably attached to a second hinge half via a pin. The first hinge half may be attached to the planar board surface of the skateboard, while the rear wheel set may be attached to the second hinge half. When in the riding position, the first hinge half may be aligned directly above the second hinge half. To move the rear wheel set for using the skateboard in the inclined or transporting configuration, the second hinge half may be pivoted about the pin with respect to both the first hinge half and the skateboard. Other elements, instead of a hinge or in addition to a hinge, may be used for moving the rear set of wheels between positions.

According to one aspect, one or more rear sets of wheels may be pivotably with respect to the skateboard to allow the skateboard to easily be converted between the riding configuration and the lading transporting configuration. When in the riding configuration, the pivotable wheel set may be positioned beneath the planar board surface of the skateboard. By positioning the wheel set under the skateboard, the riding characteristics comparable to typical skateboards may be achieved. The pivotable rear wheel set may be pivoted to a position whereby the wheels are substantially aligned with the rear edge or the skateboard or even at least partially protrude beyond the rear edge of the skateboard. As discussed above, it can be desirable to have the rear wheel set positioned so that when in the inclined or transporting position the lower end of the skateboard does not substantially interfere with the rolling of the rear wheels on a rolling surface.

According to one aspect, one or more rear sets of wheels may be slidable with respect to the skateboard between riding and lading transporting positions. When in the riding position, the slidable wheels may be positioned beneath the skateboard to allow the skateboard to be used on a roller surface in a manner similar typical skateboards. However, to use the skateboard in its inclined configuration the rear wheel set may be slid from the riding position to an extended or lading transporting position. In the extended position, the rear wheels may be substantially aligned with or even at least partially protrude beyond the rearward edge of the planar surface of the skateboard. As discussed above, having the rear wheels positioned towards or even past the rearward edge of the planar board surface may facilitate rolling use of the skateboard in its inclined configuration.

According to one aspect, an end portion of the skateboard may be pivotably or otherwise movable from generally planar alignment with the board surface to a position at an angle thereto. In one aspect, the rear end of the skateboard is pivotable via a hinge to a position substantially perpendicular with respect to the planar board surface. When the end section of the board is pivoted into its angular relationship with the planar board surface, a rear set of wheels may be substantially aligned with or at least partially protrude beyond the rearward edge of the board to facilitate rolling of the skateboard when in its inclined configuration. In one aspect, the hinged end section of the skateboard may provide a surface for at least assisting in supporting lading when in its angular position with respect to the remainder of the planar board surface.

In one aspect, the hinged end section of the skateboard may be adapted to selectively remain in either its planar relationship or its angular relationship with respect to the planar board surface.

In one aspect, a stop member may be positioned on the board that is selectively positionable to either allow or prevent the hinged end portion of the planar board surface from pivoting or otherwise moving with respect to the remainder of the planar board surface. The stop member may be positioned on the same side of the planar board surface as the wheel sets and slidable between a position where the stop prevents the end portion from pivoting and a position where the end portion may pivot to its angular relationship with respect to the board surface.

In one aspect, the stop member may be integrally formed with a handle to facilitate a user pushing or pulling the skateboard in its inclined configuration. The handle portion of the assembly may be substantially recessed beneath the skateboard when in the riding position to reduce interference between the handle and the riding characteristics of the skateboard, while stop portion of the assembly may be positioned to prevent the hinged end of the skateboard from moving to its angular relationship with the planar board surface. When the handle is extended beyond the edge or edges of the planar board surface to allow a user to grip the skateboard thereby, the stop member may be positioned to allow the hinged end of the board to pivot with respect to the planar board surface.

According to one aspect, a rear wheel set may be mounted relative to the hinged end section of the skateboard such that when the hinged section is in its angular relationship with the remained of the board, the wheels are disposed below the hinged end portion to allow the skateboard in its inclined configuration to be rolled thereby.

According to another aspect, a rear wheel set may be mounted relative to the planar board surface proximate the pivot axis of the hinged end portion. When the hinged end portion is substantially coplanar with respect to the planar board surface, the rear wheel set may be positioned to allow the skateboard to have riding characteristics similar to common skateboards. However, after the end section of the board is pivoted at an angle with respect to the rest of the board, the rear wheels may be substantially aligned with the pivot axis or at least partially protrude beyond the pivot axis to facilitate use of the skateboard in its inclined position.

According to one aspect, an end portion of the skateboard may be slidable relative to the remainder of the planar board surface between extended and retracted positions. In such a skateboard, the rear wheel set may be positioned at or near an end of the planar board surface proximate the sliding end section. Positioning the rear wheel set in such a location may allow the skateboard to have riding capabilities similar to typical skateboards when the end portion is in its retracted position, while allowing the rear wheels to be substantially aligned with or even at least partially protruding beyond the end of the planar board surface proximate the sliding end portion to facilitate rolling of the skateboard when in its inclined configuration.

According to another aspect, the sliding end portion of the skateboard may also comprise a handle portion integrally connected or formed therewith and at a opposite end of the planar board surface therefrom. The handle portion may be positionable below the planar board surface and not substantially protrude beyond edges thereof when the sliding end portion is in its extended position. However, movement of the sliding end portion to its retracted position may cause the handle portion to substantially protrude beyond the opposite end to facilitate use of the handle portion by a user, such as when the skateboard is in its inclined or transporting configuration.

According to one aspect, a handle apparatus may be provided at an end of the skateboard opposite the bottom wheel set when the skateboard is in an inclined position to allow for a user to easily pull or push the skateboard, with or without lading attached thereto.

In one aspect, the handle may be attached to the first side of the planar board surface, opposite the second or riding side of the board, to reduce interference between the handle and the user when the skateboard is in its first or riding configuration.

In another aspect, the handle assembly may comprise a handle slidable or otherwise moveable between a retracted position and an extended position. In the retracted position, the handle may be at least partially recessed beneath the planar board surface such that the handle, preferably, does not interfere with the use of the skateboard in its riding configuration. In the extended position, the handle may protrude at least partially beyond the end of the planar board surface to provide a gripping surface for the user to push or pull the skateboard in its second or transporting position.

According to one aspect, the handle of the handle assembly may comprise a U-shaped member, wherein the bottom or connecting portion of the handle may be easily used by a user to push or pull the skateboard when in its inclined configuration. According to another aspect, the handle may comprise a T-shaped member, wherein the cross or top portion of the handle may be easily used for pushing or pulling of the skateboard in its inclined configuration. Although U-shaped and T-shaped handles are discussed, other handle shapes and configurations may be equally suitable.

According to one aspect, apparatus is provided for adapting a skateboard for use in an inclined position, whereby the skateboard may be used to transport lading. A rear wheel assembly may be provided for removable attachment to an end of the planar board surface of the skateboard. The wheel assembly may allow for wheels of the wheel assembly to substantially support the skateboard in its inclined or transporting configuration to allow for the rolling transportation of lading. The wheel assembly is preferably easily removable to allow for the skateboard to be used in its riding configuration without interference due to the wheel assembly.

According to another aspect, a handle assembly may be provided that is removably attachable to an end of the skateboard opposite the end having the wheel assembly to provide a location for a user to grip for either pushing or pulling the skateboard when in its inclined configuration. The handle assembly may include straps, which may have elastic properties, for extension between the handle assembly and the bottom end of the skateboard and/or an attached wheel assembly. Similar to the above discussed wheel assembly, the handle assembly may be adapted for easy removal from the skateboard to allow for the skateboard to be used in its riding configuration without interference due to the handle assembly.

In one aspect, the transportation apparatus generally comprises a scooter. The scooter generally comprises a planar standing surface having at least a front wheel and a rear wheel. The front and rear wheels may be positioned proximate front and rear ends of the planar surface, respectively. An upwardly extending handle assembly may be provided at a front end of the scooter. The handle assembly may include one or more handle portions positionable to be gripped by a user when riding the scooter.

In one aspect, the front wheel of the scooter may be adapted to be steered by direction of the handle assembly. In another aspect, the height of the handle assembly and/or the handle portions may be adjustable to accommodate various user heights and/or preferences.

According to one aspect, the handle assembly may be pivotable relative to the planar surface between its substantially upright position and a pivoted position to convert the scooter between a riding configuration and an inclined configuration. When the scooter is in the riding configuration, the handle assembly may be positioned to allow for use of the handle by the rider, such as for gripping. When in the inclined configuration, the handle assembly may be pivoted to a position at least partially abutting or otherwise proximate or parallel to the planar standing surface of the scooter. In the inclined configuration, a user may grasp one end of the scooter and either push or pull the scooter for rolling via wheel or wheels positioned at an end of the scooter opposite the grasped end. The inclined position may be suitable for transporting lading. The inclined position may also be suitable for transporting the scooter when the user no longer wants to ride the scooter in a generally conventional manner.

According to one aspect, one or more shock absorbing mechanisms, such as springs, may be provided. The shock absorbing mechanism may be effective to absorb vibrations caused by variances in the rolling surface. The shock absorbing mechanism may be provided proximate the front and/or rear wheel or wheel sets. The handle assembly may also comprise a shock absorbing mechanism, although other potential locations and uses of shock absorbing mechanisms are contemplated.

According to one aspect, the front wheel of the scooter may be attached to the handle assembly such that pivoting the handle assembly also causes the front wheel to pivot.

According to one aspect, a gripping handle may be provided for a user to grasp for pulling or pushing the scooter in its inclined or transporting configuration.

In one aspect, the handle may have a gripping portion disposed in front of the front wheel when the handle assembly is in the upright position. The handle may act as a front bumper, providing protection for the front wheel. When the handle assembly is pivoted to convert the scooter to its inclined configuration, the front wheel integral with the handle assembly may pivot away from the gripping portion of the handle to allow the handle to easily be grasped without substantial interference from the front wheel.

The handle may be slidable with respect to the planar standing portion between extended and retracted positions. In the retracted position, the handle may be positioned between an end of the planar surface and a front wheel of the scooter. In the extended position, the handle may protrude beyond the front wheel of the scooter. The handle may be mounted to a side of the planar standing surface of the scooter, such as on the top or the bottom. The planar standing surface may have hollow portions in which at least part of the handle may be slidable.

The gripping handle may comprise a generally Ushaped member having curved corners. In another aspect, the gripping handle may comprise a generally U-shaped member having rectangular corners. In yet another aspect, the gripping handle may comprise a diamond or triangular shaped member, although other handle configurations are contemplated.

A brake mechanism may be provided to assist in stopping or slowing of the scooter, such as when the scooter is in motion. The brake mechanism may be operated by a foot of the rider to apply a stopping force to a rear wheel, if there is just one rear wheel, or to at least one rear wheel, if there are a plurality of rear wheels. The brake mechanism may also function as a support for the scooter when in its inclined or transporting configuration. The brake mechanism may comprise a hand-operated front and/or rear wheel brake, although other braking mechanisms are contemplated.

A wheel set may include a plurality of wheels that are movable between an in-line configuration and a parallel configuration. The in-line wheel configuration may be desirable for riding the scooter. However, the parallel wheel configuration may be desirable for riding the scooter when greater stability is desired, such as when a small child is riding the scooter or when a user is learning to ride the scooter. The parallel wheel configuration may also be desirable when the scooter is in its inclined position, such as to provide greater stability to the scooter when the scooter is being rolled via the parallel wheels.

The wheels may also be attached to an axle or other mechanism adapted to selectively adjust the spacing between wheels in the parallel configuration to further increase the distance therebetween to improve stability of the scooter, both in the riding and inclined configurations. Locking or other securing mechanisms may be provided to selectively maintain the wheels and wheel assemblies in their in-line or parallel configurations. A wheel set may include two wheels. The wheel set may be positioned at a rear end of the scooter, opposite the end of the scooter proximate the handle assembly. One or more wheels may be selectively lockable to prevent or reduce unwanted rotation of the wheels.

The personal transportation apparatus and/or lading may be adapted for securing the lading relative to the apparatus. Although certain devices and ways are discussed below for securing the lading relative to the personal transportation apparatus, other ways for attaching the lading relative to the apparatus are contemplated.

The apparatus may be adapted for carrying lading by providing one or more hooks or other such device on the planar surface of the skateboard or scooter. The hook may be mounted on either side of the planar surface. The hook may be mounted proximate an end of the planar surface opposite the bottom wheels when the apparatus is in its inclined configuration. The lading may include a loop or other mechanism to allow for support by the hook.

If the personal transportation apparatus includes a handle, the handle may be used as a hook to enable the loop of the lading to be positionable thereover to at least partially secure the lading relative to the skateboard or scooter.

The personal transportation apparatus may be adapted for carrying lading by providing one or more straps to secure the lading to the apparatus. In one aspect, the straps may be secured to the skateboard or scooter and adapted to at least partially wrap around or attach to the lading. In another aspect, the straps may be secured to the lading and adapted to at least partially wrap around or attached to the skateboard or scooter. In yet another aspect, the straps may be provided as separate members for wrapping around or otherwise securing both the lading and the skateboard or scooter relative to each other.

The personal transportation apparatus may be adapted for carrying lading by providing one or more nets to secure the lading to the apparatus. The nets may comprise a plurality of elastic elements for securing the lading relative to the apparatus.

The handle assembly of the scooter may be adapted for securing the lading relative to the scooter. The handle assembly in its pivoted position generally parallel to the planar standing surface may compress the lading against the standing surface.

In another aspect, the handle portions may be removable from the handle assembly for use in securing the lading relative to the scooter. The removable handle portions may include straps, chords, or other such devices, such as chords having elastic properties, extending between the handle assembly and the removable handle portions for use in securing the lading.

Straps or chords may be provided in a retracted state within or otherwise attached to the planar riding or standing surfaces of the personal transportation apparatus for use in securing the lading relative to the apparatus.

A lading support surface may be provided on the personal transportation apparatus for supporting the lading. The lading support surface may be movable between a position wherein it does not substantially interfere with riding of the apparatus and a position whereby lading may be supported thereby.

The lading may comprise a pack that is provided with the personal transportation apparatus. The pack may be adapted to be worn or otherwise carried by a user of the skateboard or scooter, such as when the skateboard or scooter is being ridden by the user. The pack may comprise a backpack, although other types of lading are contemplated.

The personal transportation apparatus itself may comprise the lading, with the apparatus adapted for the apparatus to be pushed or pulled in an inclined or other position. Such a transporting position may allow a skateboard to scooter according to be transported in manner that reduces the burden or weight associated with entirely carrying the apparatus by the user.

The rear wheels, rear wheel sets, or rear end portions have been used in summarizing aspects of the invention. However, it is contemplated that the front wheels, front wheel sets, or front end portions of the skateboard may similarly be modified.

A personal transportation apparatus, such as a scooter or skateboard, can be converted from a riding configuration to a transporting configuration. In the transporting configuration, the apparatus may also be used to transport lading, such as a pack or bag. The transporting configuration also may provide for easy transportation of the apparatus itself.

One or more wheel sets may be moved from a riding position to a transporting position. In the transporting position, the wheels may provide for easy rolling of the apparatus. In the riding position, the wheels may provide for riding of the apparatus.

A handle may be accessible or selective accessible to provide for easy pulling or pushing of the apparatus in the transporting configuration. Once transporting is no longer desired, the apparatus may be returned to its riding configuration.

A clamping assembly may be provided for securing the personal transportation apparatus or device to another such device or a vehicle. Clamping jaws may be provided having gripping elements attached thereto. The jaws, and thus the gripping elements, can be biased toward each other to clamp to a personal transportation device by a resilient biasing member. Two or more clamping assemblies may be used to secure the personal transportation device to the other such device or vehicle.

While transportation apparatus comprising skateboards and scooters are discussed above, adapting or configuring other types of personal transportation is also contemplated.

### BRIEF DESCRIPTION OF THE DRAWINGS

FIG. 1(a) is a back elevation view of a transportation apparatus having a pack attached thereto;

FIG. 1(b) is a side elevation view of the transportation apparatus and pack of FIG. 1(a);

FIG. 2(a) is a back elevation view of a transportation apparatus having a pack attached thereto;

FIG. 2(b) is a side elevation view of the transportation apparatus and pack of FIG. 2(a);

FIG. 3 is a back elevation view of a transportation apparatus having a hinged rear truck;

FIG. 4 is a back elevation view of a transportation apparatus having a pivotable rear truck;

FIG. 5 is a back elevation view of a transportation apparatus having a slidable rear truck;

FIG. 6(a) is a back elevation view of a transportation apparatus having a pivotable end portion shown in a first position;

FIG. 6(b) is a side elevation view of the transportation apparatus of FIG. 6(a) showing the pivotable end portion in a second position;

FIG. 7(a) is a back elevation view of a transportation apparatus having a pivotable end portion shown in a first position;

FIG. 7(b) is a side elevation view of the transportation apparatus of FIG. 7(a) showing the pivotable end portion in a second position;

FIG. 8 is a back elevation view of a transportation apparatus;

FIG. 9 is a back elevation view of a transportation apparatus;

FIG. 10 is a perspective view of a system for adapting a transportation device for carrying a pack;

FIG. 11 is a perspective view of a system for adapting a transportation device for carrying a pack;

FIG. 12 is a perspective view of a transportation device having a handle apparatus shown in an extended position;

FIG. 13 is a side view of the transportation device of FIG. 12 showing the handle apparatus in a retracted position;

FIG. 14 is a back elevation view of a transportation device having a handle apparatus shown in a retracted position;

FIG. 15 is a perspective view of the transportation device of FIG. 14 showing the handle apparatus in an extended position;

FIG. 16 is a back elevation view of a transportation device having a handle apparatus shown in a retracted position;

FIG. 17 is a back elevation view of a transportation device having a handle apparatus shown in a retracted position;

FIG. 18 is a perspective view of a transportation device;

FIG. 19 is a perspective view of a transportation device;

FIG. 20(a) is a back elevation view of the transportation device of FIG. 19;

FIG. 20(b) is a back elevation view of a rear wheel set according to another aspect of the transportation apparatus of FIG. 19;

FIG. 21 is a back elevation view of a transportation apparatus having a handle apparatus shown in a retracted position;

FIG. 22 is a back elevation view of the transportation apparatus of FIG. 21 having a pack attached thereto;

FIG. 23 is a side elevation view of a transportation apparatus having a handle apparatus shown in a retracted position and a pack attached thereto;

FIG. 24 is a perspective view of a transportation device having a handle apparatus shown in an extended position;

FIG. 25 is a side elevation view of a transportation device having a handle apparatus shown in a retracted position;

FIG. 26 is an end view of a transportation device held by clamping jaws of a clamping assembly shown with a portion of a clamping jaw broken away for illustration;

FIG. 27 is a view of the clamping assembly of FIG. 26 shown without the transportation device held between the clamping jaws thereof;

FIG. 28 is an end view of the transportation device having lading attached thereto and held by the clamping assembly of FIG. 26; and

FIG. 29 is a perspective view of the clamping assembly of FIG. 26.

### DETAILED DESCRIPTION

Apparatus for transporting both riders and lading and/or the apparatus itself, wherein the apparatus is convertible between a riding configuration and a lading and/or apparatus transporting configuration, are disclosed below.

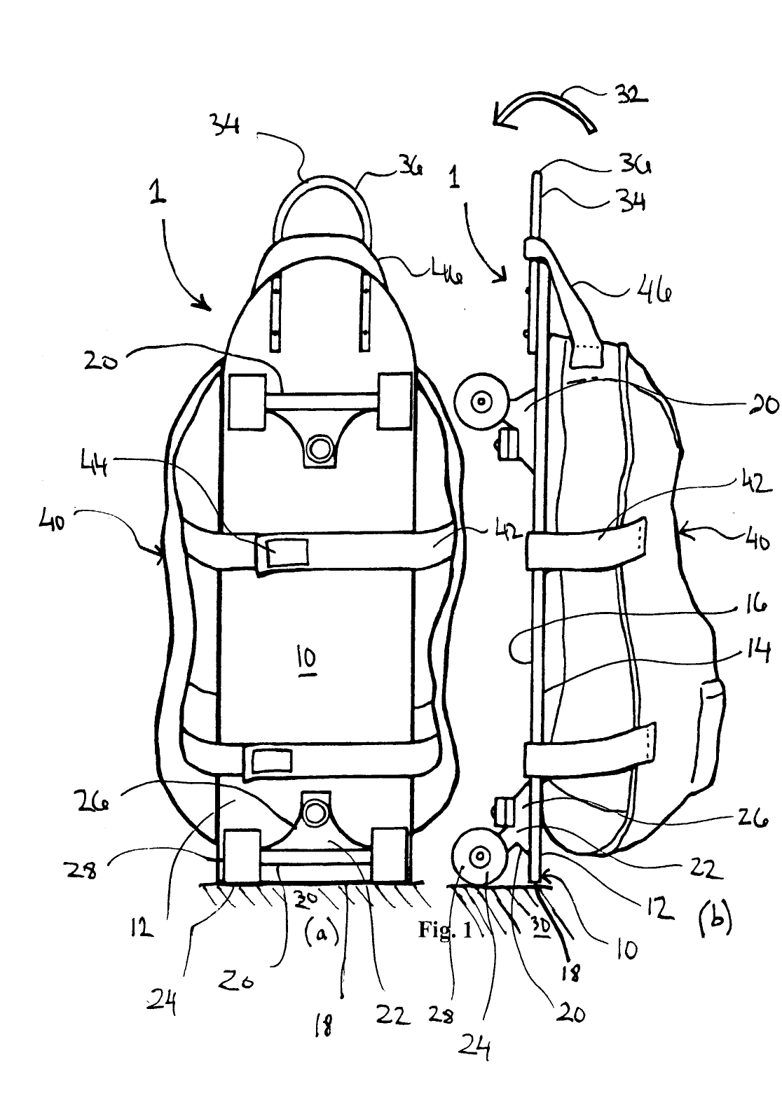

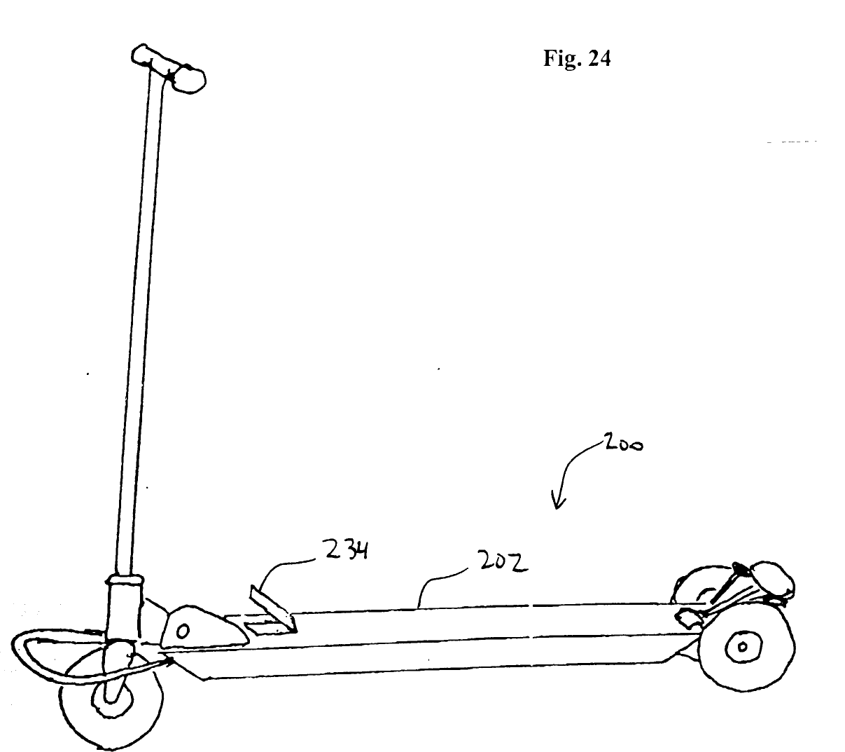

FIGS. 1-25 illustrate apparatus for transporting both riders and lading and/or the apparatus itself. The apparatus generally may comprise a personal transportation device having a riding configuration and a transporting configuration. In the riding configuration, the apparatus may be ridden by a user. In the transporting configuration, the apparatus may be used to transport the apparatus itself and/or lading secured relative thereto. The apparatus is easily convertible between the riding and transporting configurations.

FIGS. 1-9 illustrate a personal transportation apparatus 1 generally comprising a skateboard 10. The skateboard 10 is convertible between riding and transporting configurations. The skateboard comprises a substantially planar board 12 having a riding surface 14 and a surface 16 with wheels sets 20 attached thereto opposite the riding surface 14. The wheel sets 20 comprise trucks 22 having a wheel 24 mounted at each end thereof to allow the skateboard 10 to be rolled on a rolling surface 30.

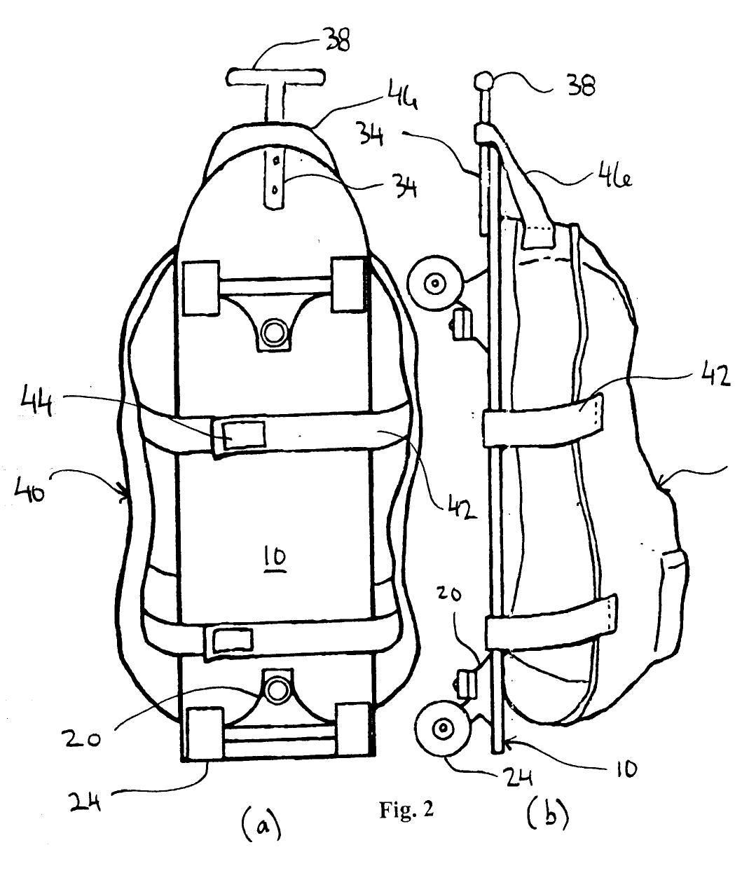

FIGS. 1 and 2 illustrate a skateboard 10 having a rear set of wheels 26 have wheels 28 with an outer diameter substantially aligned with a bottom edge 18 of the board 12. While illustrated in an upright position, the skateboard 10 can be tilted in the direction shown by the arrow 32 of FIG. 1(b) to enable the skateboard 10 to roll on the rolling surface 30 without the end of the board 18 interfering with the rolling surface 30.

The skateboard 10 of FIGS. 1 and 2 has a handle 34 positioned to allow the skateboard 10 to easily be pulled or pushed by a user when the skateboard 10 is in its inclined or upright position. The handle 34 allows the user to securely grip and guide the skateboard 10. The handle 34 may comprise a U-shaped member 36, as illustrated in FIG. 1, or a T-shaped member 38, as illustrated in FIG. 2.

A pack 40 is selectively attachable to the skateboard 10. A plurality of straps 42 are attached to the pack 40 and can wrap around the board 12 and attach to each other, such as with velcro strips 44, proximate the wheel attachment surface 16 to hold the pack 40 against the riding surface 14, as illustrated in FIGS. 1 and 2. Although straps 42 are illustrated as being attached to the pack 40, straps attached to the skateboard 10 or even separate straps may be used for securing the pack 40 relative to the skateboard. The apparatus is not limited to using straps 42, and other ways are contemplated for securing the pack 40 relative to the skateboard 10. For example, netting may be provided for securing the pack 40 relative to the skateboard 10. The pack 40 may also include a loop 46 for fitting over and around the handle 34 to additionally secure the pack 40 relative to the skateboard 10.

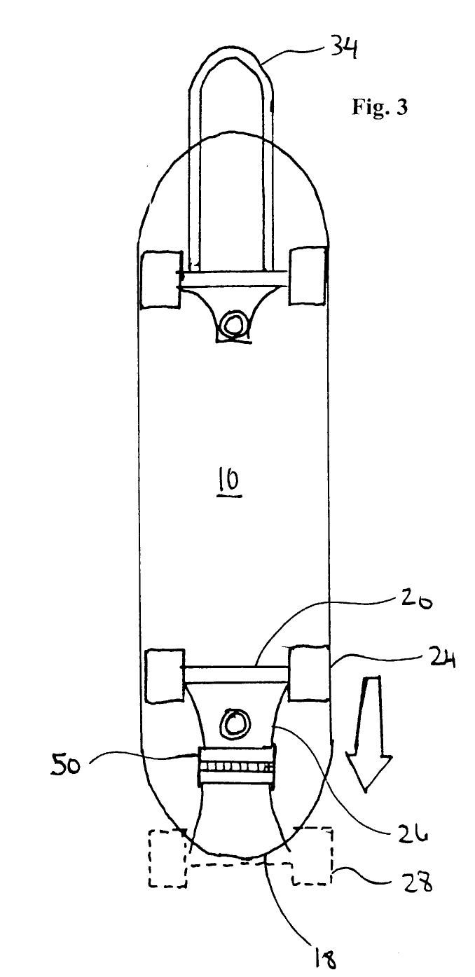

FIG. 3 illustrates a skateboard 10 having the rear set of wheels 26 pivotable about a hinge 50 between a position entirely beneath the board 12 and a position wherein the outer diameter of the rear wheels 28 protrude beyond the lower edge 18 of the board 12. When entirely beneath the board 12, the rear wheel set 26 are positioned to allow the skateboard 10 to be used in its riding configuration. The rear wheel set 26 is preferably positioned such that the skateboard 10 has generally similar riding characteristics as compared to typical skateboards. However, when moved via the hinge 50 to a position at least partially beyond the bottom edge 18 of the board 12, the rear wheels 28 may contact a rolling surface without substantial interference between the board 12 and the rolling surface to facilitate use of the skateboard 10 in its inclined configuration. The hinge 50 may be adapted to ensure that the rear wheel set 26 does not move between positions unless desired. Although a hinge 50 is illustrated, other suitable elements may be used for allowing the rear wheel set 26 to move between positions.

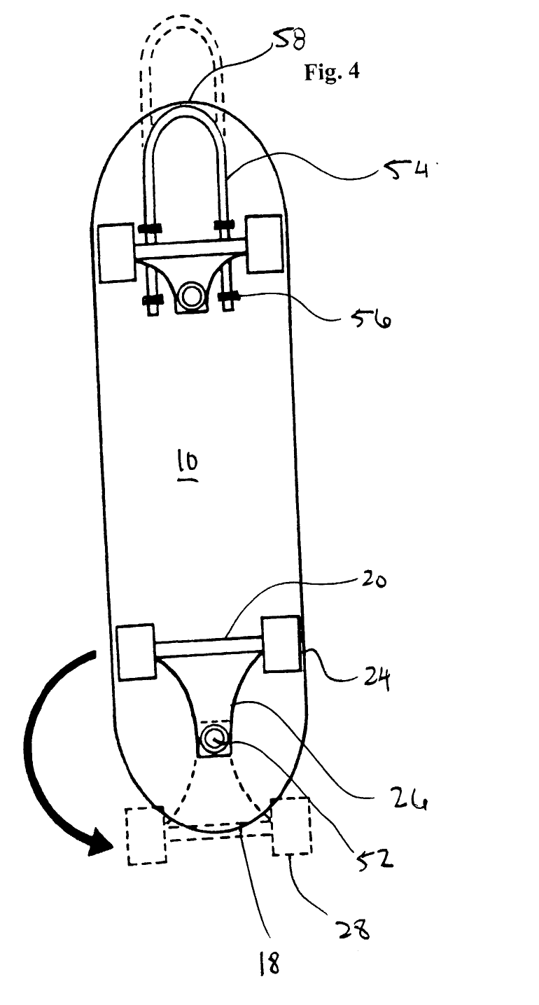

FIG. 4 illustrates a skateboard 10 having the rear set of wheels 26 pivotable about a pivot between a first position generally within the edges of the board 12 and a second position wherein the outer diameter of the rear wheels 28 protrude beyond the bottom edge 18 of the board 12. Similar to the hinge 50 of FIG. 3, pivoting the rear wheel set 26 to the first position allows for the skateboard 10 to be used in its riding position, while pivoting the rear wheel set 26 to the second position allows for the skateboard 10 to be easily rolled in its inclined position. The pivot 52 may be adapted to ensure that the rear wheel set 26 does not move between the first and second positions unless desired.

FIG. 4 also illustrates a handle 54, similar to the U-shaped handle member 36 of FIG. 1. However, the handle 54 of FIG. 4 is adapted to slide between an extended position, illustrated in dashed lines, and a retracted position, illustrated in solid lines. The handle 54 is attached to the wheeled surface 16 of the board 12 with attachment members 56 that allow the handle 54 to slide relative thereto, but still are effective to retain the handle 54 relative to the board 12. When in the retracted position, the handle 54 does not protrude beyond the front edge 58 of the board 12, minimizing any interference that may be caused by the handle 54 when the skateboard 10 is used in its riding configuration. When the skateboard 10 is to be used in its inclined configuration, the handle 54 may be translated to its extended position, whereby it can easily be gripped by a user and used to push or pull the skateboard 10.

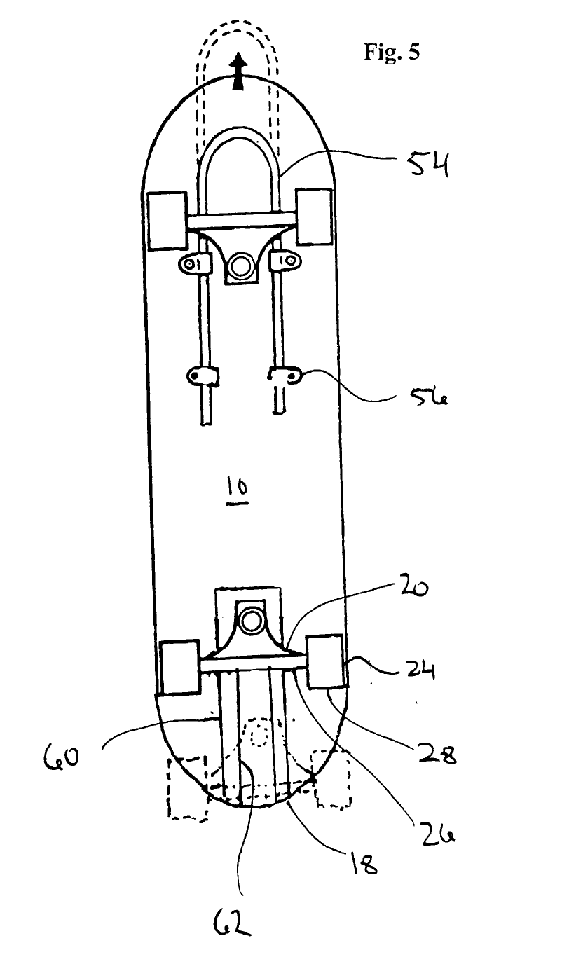

FIG. 5 illustrates a skateboard 10 wherein the rear wheel set 26 is slidable between a first position entirely within the edges of the board 12 and a second position wherein the outer diameter of the rear wheels 28 at least partially extend beyond the bottom edge 18 of the board 12. The rear wheel set 26 is slidable within a channel 62 forming in a track 60 mounted to the rolling surface 16 of the skateboard 10. Similar to the hinge 50 of FIG. 3 and pivot 56 of FIG. 4, sliding the rear wheel set 26 to the first position allows for the skateboard 10 to be used in its riding configuration, while pivoting the rear wheel set 26 to the second position allows for the skateboard 10 to be easily rolled in its inclined configuration without the bottom edge 18 of the board 12 substantially interfering with the rolling. Also similar to the hinge 50 and pivot 52, the slidable track 60 and/or the rear wheel set 26 may be adapted to ensure that the rear wheel set 26 does not move between the first and second positions unless desired.

As illustrated in FIG. 5, the handle member 54 is translatable between extended and retracted positions, generally for the purposes and with the same general structure as the handle 54 discussed above with respect to FIG. 4.

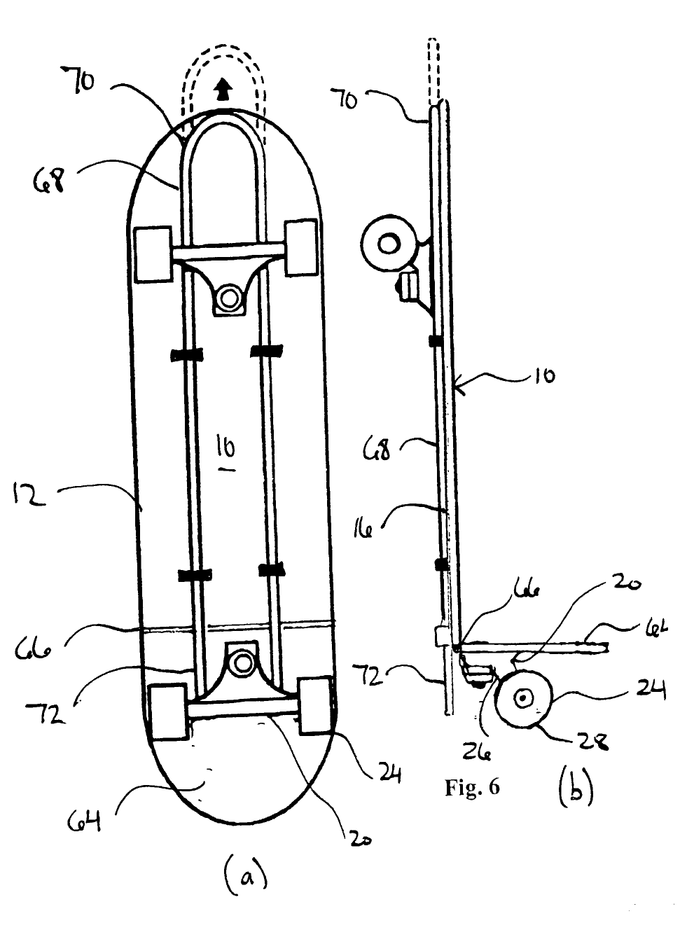

FIG. 6 illustrates a skateboard 10 wherein a bottom end portion 64 of the board 12 is pivotable about a hinge 66 between a coplanar alignment with the board 12, illustrated in FIG. 6(a), and an angular alignment with the board 12, illustrated in FIG. 6(b). The rear wheel set 26 is attached to the end portion 64 and aligned such that when the end 64 is in its coplanar arrangement the wheels 28 are positioned to allow the skateboard 10 to be used in its riding configuration. However, when the end 64 is pivoted to its angular orientation, the rear wheels 28 are positioned to allow the skateboard 10 to be used in its inclined configuration. In addition, the end 64 may provide support for the lading, such as the pack 40, when the skateboard 10 is used in its inclined configuration.

In order to prevent unwanted movement of the end portion 64 from the coplanar to the angular arrangements, a stop member 68 is provided on the rolling side 16 of the of the board 12. The stop member 68 is translatable between extended and retracted positions. When in the retracted position, a handle portion 70 of the stop member 68 is positioned to not substantially protrude beyond the upper edge 58 of the board 12. Also when in the retracted position, blocking parts 72 of the stop member 68 extend beyond the hinge 66 to provide support for the end 64 in its coplanar arrangement, as illustrated in FIG. 6(a). When the end 64 is in its angular arrangement, the blocking parts 72 provide support for the skateboard 10 when it is in a resting position in its inclined configuration, such as illustrated in FIG. 6(b). Translation of the stop member 68 to its extended position, illustrated in dashed lines, allows the handle portion 70 to protrude beyond the upper end 58 of the board 12 to facilitate pulling or pushing of the skateboard 10 in its inclined configuration. The extended position of the stop member 68 also moves the blocking parts 72 upwardly toward the hinge 66 to reduce interference between the parts 72 and the rolling surface when the skateboard 10 is used in its inclined configuration.

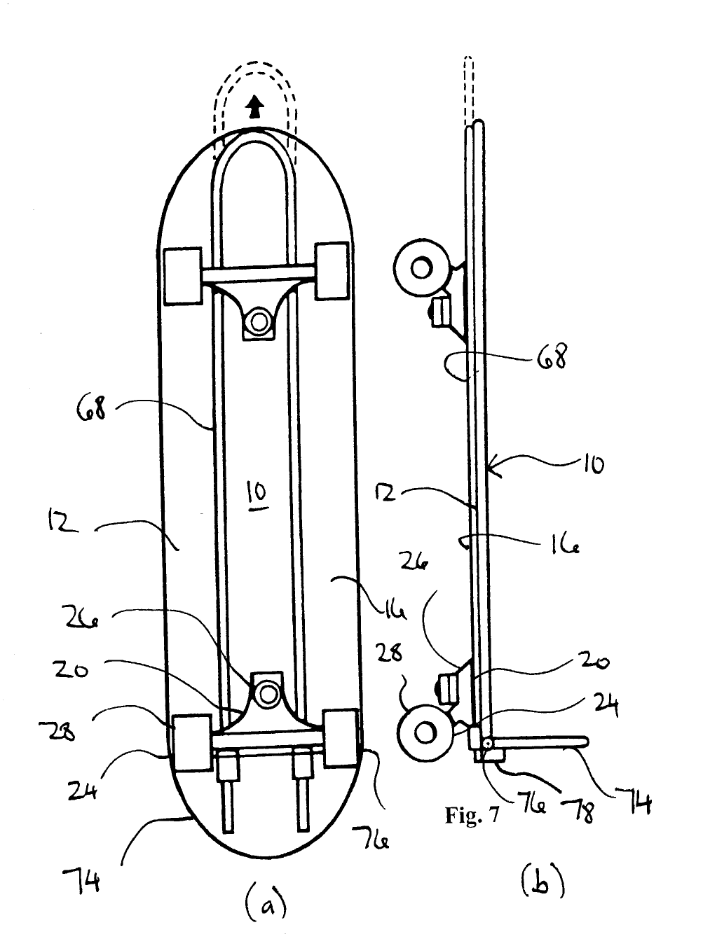

FIG. 7 illustrates a skateboard 10 having an end portion 74 of the board 12 pivotable about a hinge 76 between coplanar and angular arrangements with respect to the board 12. Instead of having the rear wheel set 26 positioned on the end portion 74, as in the skateboard 10 illustrated in FIG. 6, the rear wheel set 26 of the skateboard 10 of FIG. 7 are mounted relative to the rolling surface 16 of the board 12. When the end 74 is in its angular arrangement, the rear wheels 28 are substantially aligned with the end of the board 78. As discussed above, the positioning of the rear wheels 28 can allow for the skateboard 10 to be used in its inclined configuration without substantial interference by the end of the board 78. A stop member 68, similar in operation and purpose to the stop member 68 discussed with respect to FIG. 6, is provided on the board 12.

Although stop member 68 is illustrated and described hereinabove, other suitable mechanisms for preventing unwanted movement between the board 12 and the ends 64 or 74 are contemplated. Also, the apparatus is not limited to the use of hinges 66 or 76, and other suitable ways or means for moving the end sections 64 or 74 relative to the board 12 are contemplated. Furthermore, the locations and relative lengths of the ends 64 or 74 are not limited to that described hereinabove or illustrated in the figures, and other suitable end sizes or relative positions are contemplated.

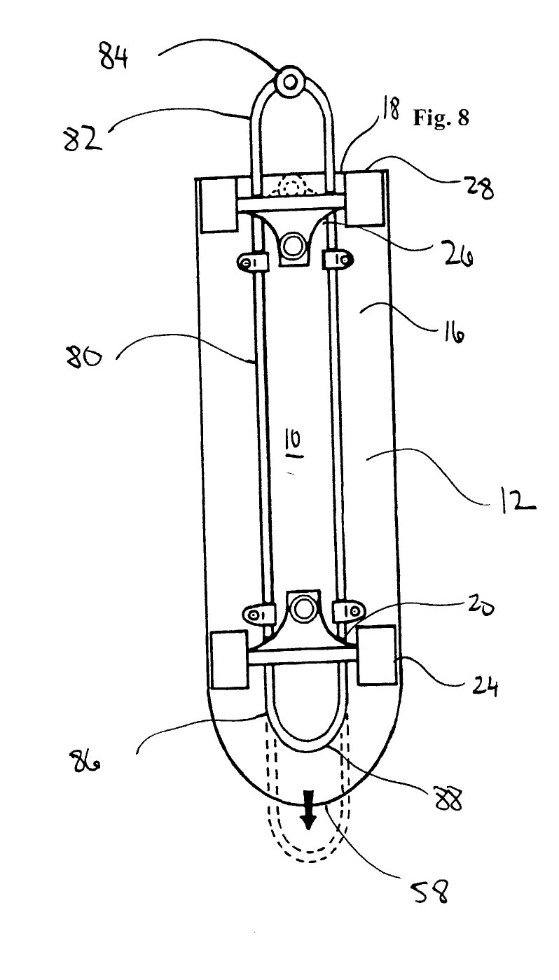

FIG. 8 illustrates a skateboard 10 having a skating assembly 80 attached to the rolling surface 16 of the board 12 and is translatable relative to the board 12 between extended and retracted positions. When in the extended position, an end 82 of the assembly 80 protrudes beyond the bottom end 18 of the board 12 to provide a surface for a foot of a rider to rest or use to maneuver the skateboard 10. A pad 84 or other surface may be provided on the end 82 to provide additional surfaces for a rider to use. In the retracted position, the end 82 is substantially positioned in alignment with the bottom edge 18 of the board 12 to allow the rear wheels 28 to be aligned therewith to facilitate rolling of the skateboard 10 in its inclined position, as discussed above.

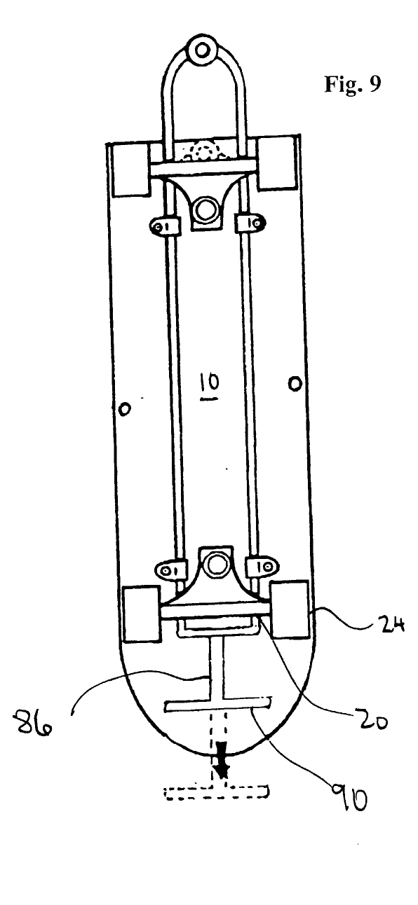

Opposite the end 82 is an integral handle portion 86. The handle portion 86 protrudes beyond the 58 front edge of the board 12 when the assembly 80 is in its retracted position, as illustrated in dashed lines, and does not protrude when the assembly is in its extended position, as illustrated in solid lines. While the handle portion 86 of FIG. 8 comprises a generally U-shaped member 88, FIG. 9 illustrates a similar assembly 82 having a T-shaped member 90 for the handle portion 86, although other suitable handles are contemplated.

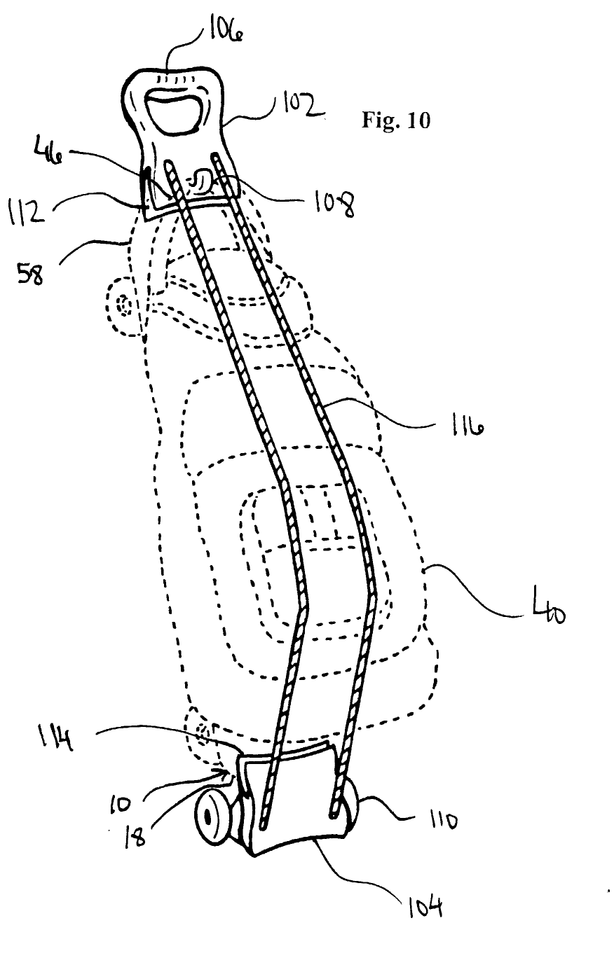

FIG. 10 illustrates apparatus wherein a handle assembly 102 and wheel assembly 104 are positionable relative to skateboard 10. The handle and wheel assemblies 102 and 104 can allow a skateboard 10 easily to be adapted for conversion to a lading and/or apparatus transporting configuration. For example, a typical skateboard may use the handle and wheel assemblies 102 104 to allow the skateboard to be converted between a riding position, whereby the assemblies 102 and 104 are removed from the skateboard, and a skateboard and/or lading transporting configuration, whereby the assemblies 102 and 104 are attached to ends of the skateboard. The assemblies 102 and 104 are preferably formed of a polymer to provide a durable yet lightweight apparatus. However, other materials may be equally suitable.

The wheel assembly 104 comprises a slot 114 adapted to permit insertion of the bottom edge 18 of the skateboard 10. Similarly, the handle assembly 102 comprises a slot 112 adapted to permit insertion of the top edge 58 of the skateboard 10. A plurality of chords 116, such as elastic chords, extend between the handle and wheel assemblies 102 and 104. The chords 116 may assist in securing the pack 40 relative to the skateboard 10. The slots 112 and 114 may be sized to provide at least a partial frictional fit between the board edges 58 and 18 and the respective slots 112 and 114 to secure that assemblies 102 and 104 relative to the skateboard. The chords 116 may also secure the assemblies 102 and 104 relative to the skateboard 10, or a combination of a friction fit and chords 116 may be used.

The wheel assembly 104 additional comprises a pair of wheels 110 adapted to allow for rolling transport of the skateboard 10 in its inclined configuration when positioned thereon. The handle assembly 102 may also include a hook 108 to allow for the loop 46 of the pack 40 to provide additional support for the pack 40. A gripping portion 106 may also be provided to allow for a user to easily grip the handle assembly 102.

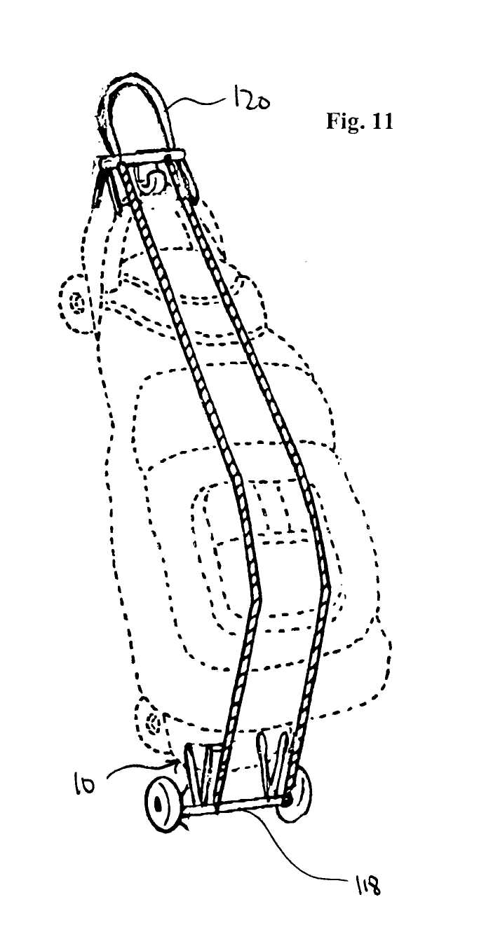

FIG. 11 illustrates apparatus, similar to the apparatus illustrated in FIG. 10, whereby removable wheel and handle assemblies 118 and 120 are provided for use with a skateboard.

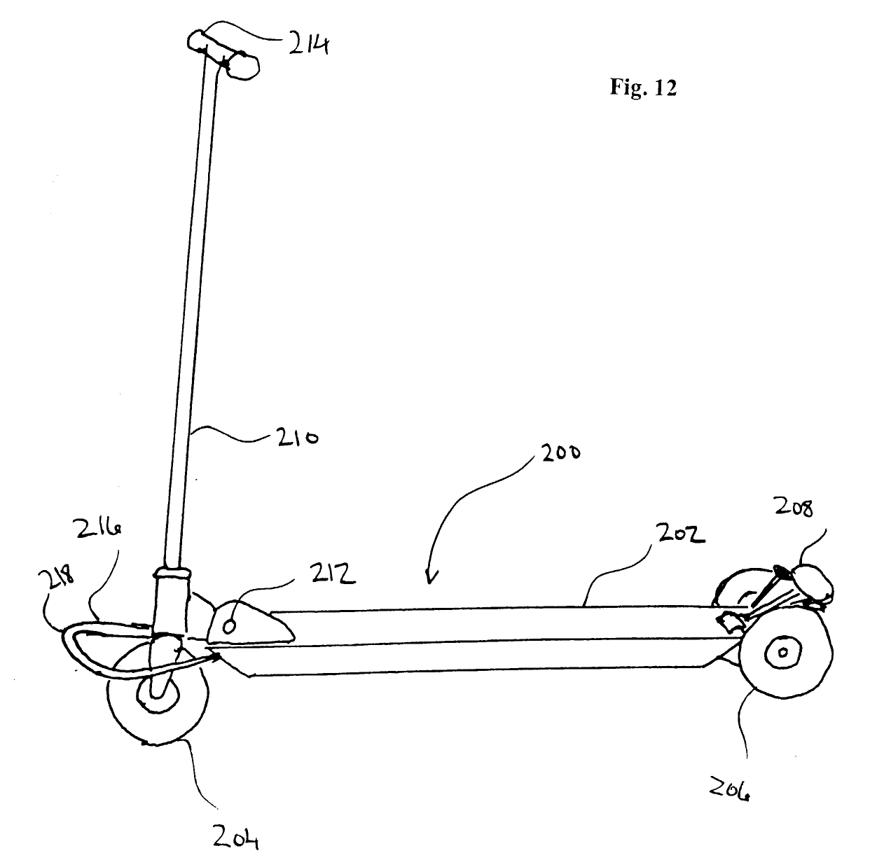

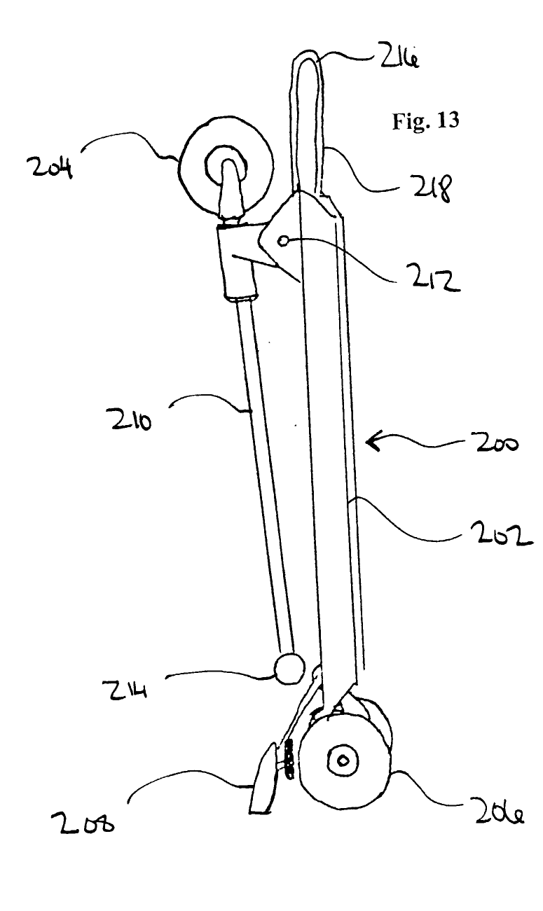

FIGS. 12 and 13 illustrate a scooter 200 generally comprises a generally planar riding surface 202 having a front wheel 204 and two rear wheels 206. A single rear wheel or other wheel configurations may also be used. A brake assembly 208 may be provided to stop or slow the scooter 200. A handle assembly 210 extends upwardly from the riding surface 202 and has a gripping portion 214 to allow for a rider to grasp the assembly 210, such as to steer or maintain balance. The handle assembly 210 may be adjustable in height to accommodate riders of differing heights or preferences.

The scooter 200 is convertible between a riding configuration, illustrated in FIG. 12, and an inclined configuration, as illustrated in FIG. 13. In the riding position, the handle assembly 210 may extend upwardly from the riding surface 202. To convert the scooter 200 to an inclined configuration, the handle assembly 210 may be pivoted about a pivot or hinge 212, such that the handle assembly 210 is generally parallel to the riding surface 202. In the inclined position, the rear wheel or wheels 206 contact the rolling surface, while a handle 216 at the opposite end of the riding surface 202 allows a user to pull or push the scooter 200. The inclined position allows scooter 200 to easily be transported by a user, or allows for a pack or other lading to be secured thereto for transport. The brake assembly 208 may also function as a stand to assist in supporting the scooter 200 in a vertical position. The brake assembly may be able to substantially lock the wheels 206 to prevent unwanted rolling thereof, such as if the scooter 200 in its transporting configuration is desired to be stationary. Other ways of locking the wheels 206 are also contemplated.

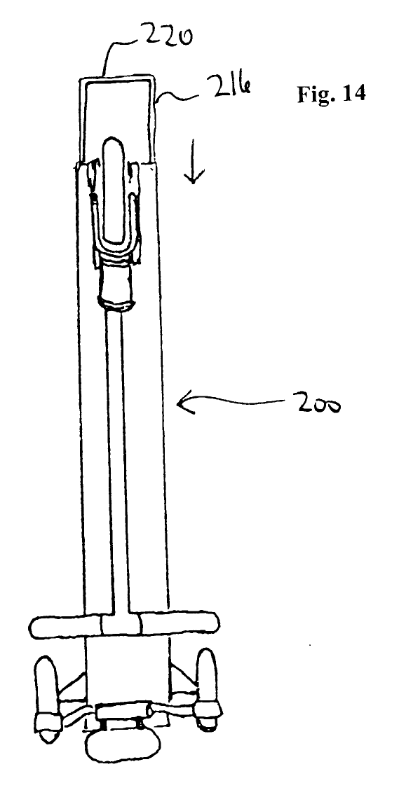

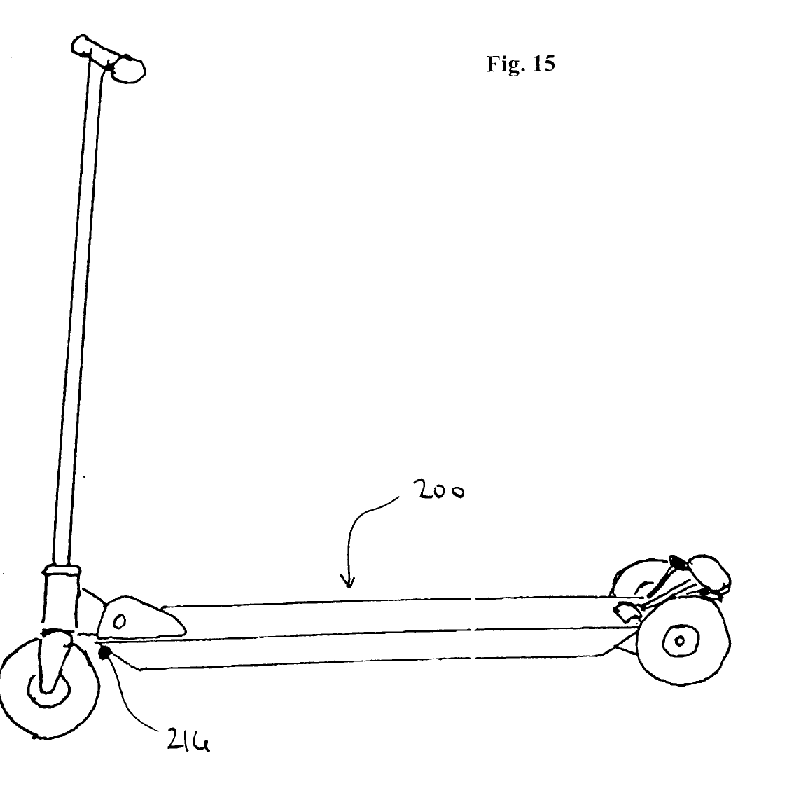

The handle 216 may be fixed relative to the scooter 200, or the handle 216 may be translatable with respect to the riding surface 202, as illustrated in FIGS. 14 and 15. The handle 216 may be configured to act as a bumper. If the riding surface 202 has a hollow region, the handle 216 may be at least partially recessible therewithin when not is use, as illustrated in FIG. 15.

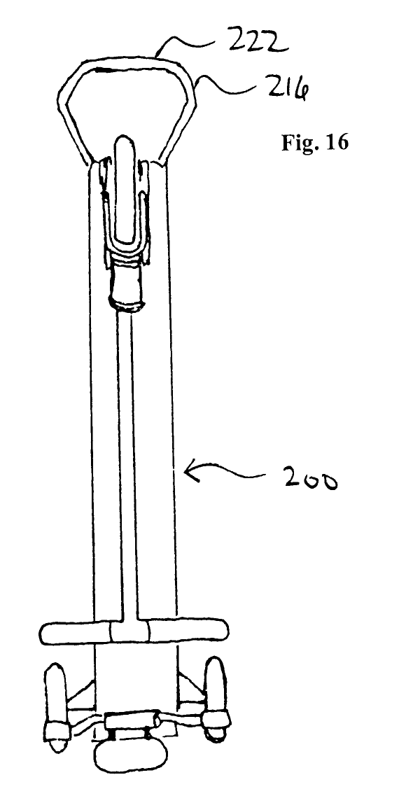

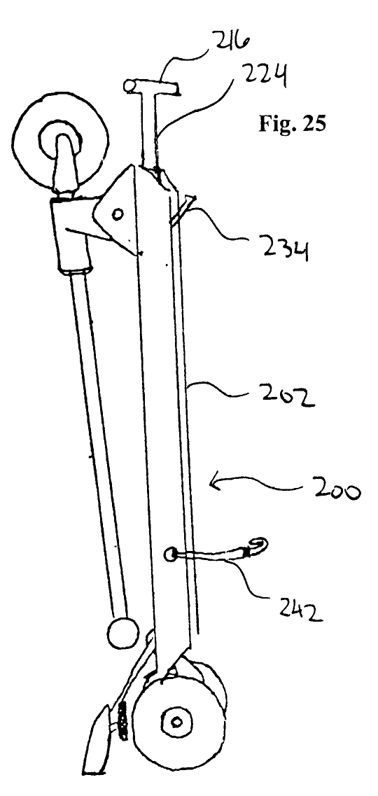

The handle 216 may comprise a U-shaped member 216 having curved corners, as illustrated in FIGS. 12 and 13, or a U-shaped member 220 having rectangular corners, as illustrated in FIGS. 14 and 15, although other handle 216 configurations may be equally suitable and are contemplated. For example, the handle 216 may comprise a generally triangular member 222, as illustrated in FIGS. 16-24, or a T-shaped member 224 as illustrated in FIG. 25.

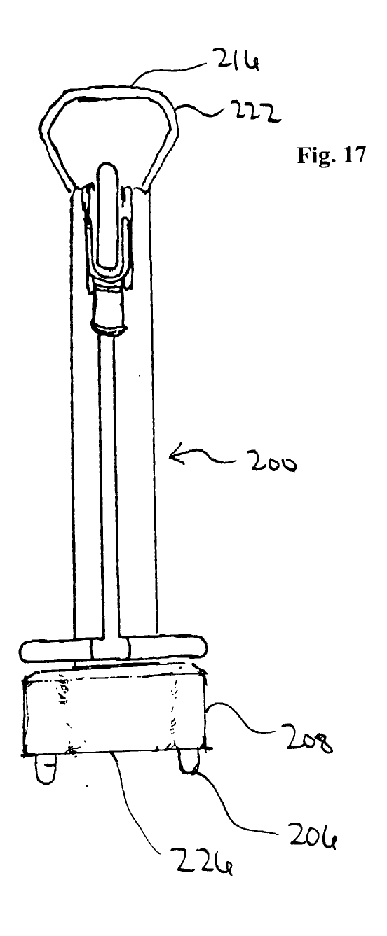

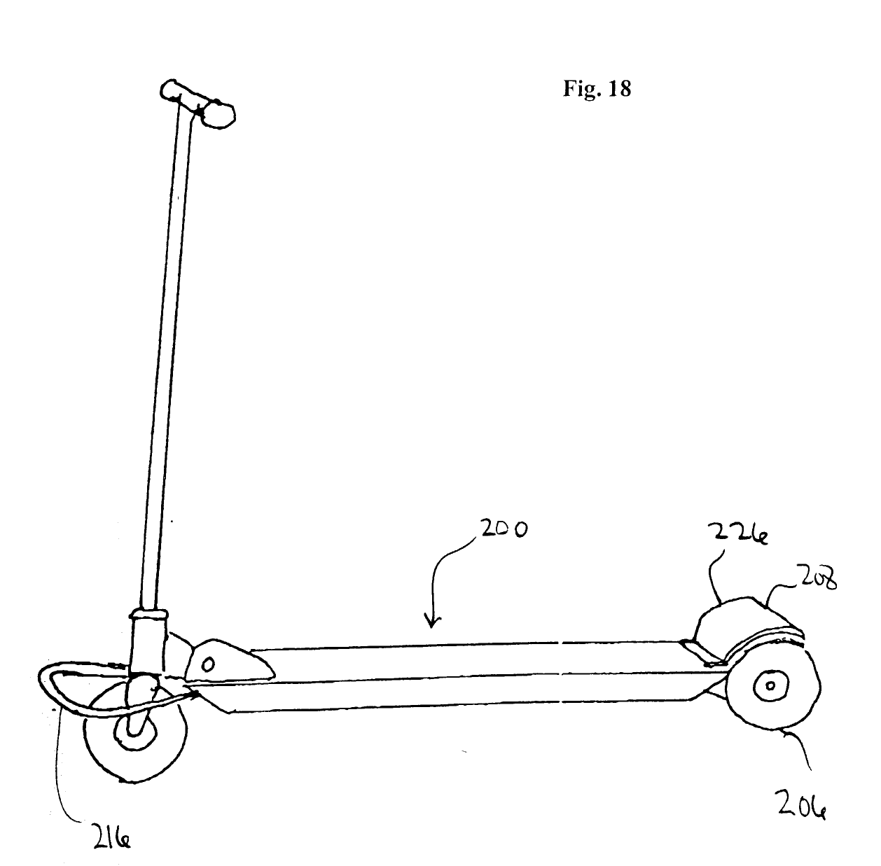

The brake mechanism 208 of the scooter 200 may comprise a cover 226 extending over the rear wheel or wheels 206, as illustrated in FIGS. 17 and 18, movable thereagainst to provide braking action. The cover 226 or other elements may be used for preventing or reducing contact between lading and the wheels 206 when the scooter 200 is in its transporting position.

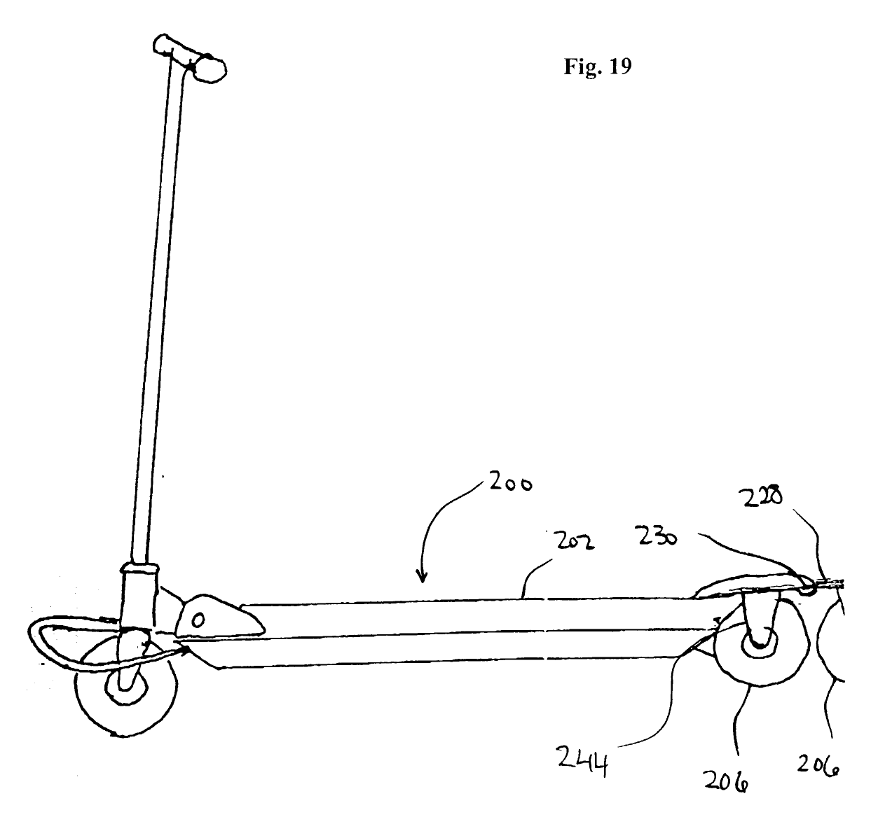

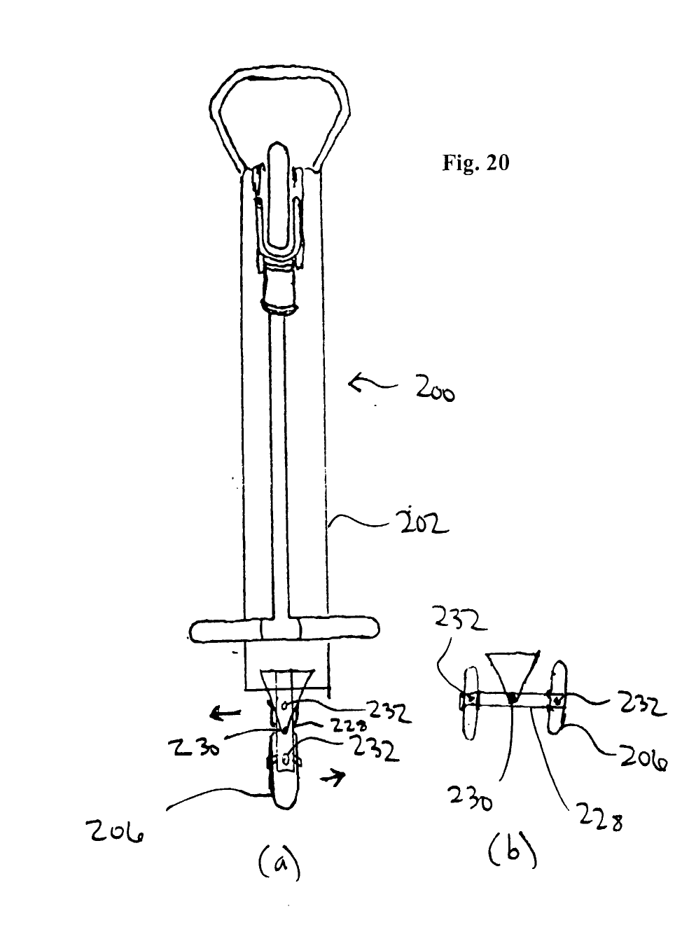

As illustrated in FIGS. 19 and 20, the scooter 200 can have two rear wheels 206 convertible between in-line positions, illustrated in FIGS. 19 and 20(a), and parallel positions, illustrated in FIG. 20(b). The in-line position may provide improved handling characteristics, while the parallel arrangement may provide improved stability in either the riding or inclined configurations of the scooter 200.

The wheels 206 are attached to brackets 244 pivotable about a pivot 232 with respect to a cross linkage 228. The cross linkage 228 is itself pivotable with respect to the riding surface 202 about a pivot 232. Thus, to move the rear wheels 206 from an in-line position to a parallel position requires pivoting the wheels 206 with respect to the linkage 228 and the linkage 228 with respect to the riding surface 202. The pivots 232 and 230 may be adapted to prevent unwanted pivoting of the wheels 206 and cross linkage 228, respectively.

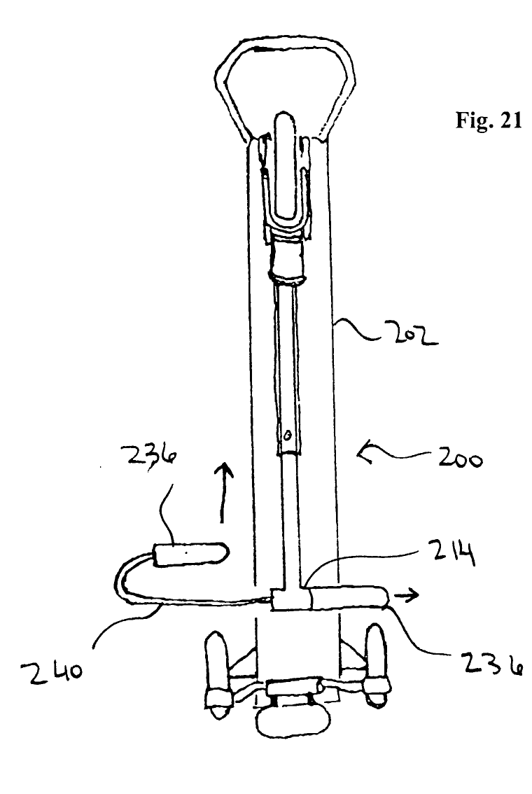

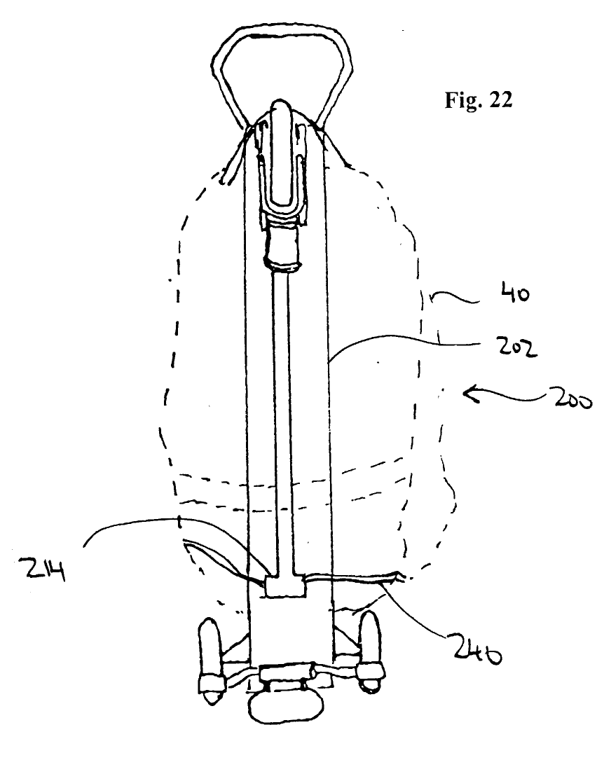

FIGS. 21 and 22 illustrate the scooter 200 having the handle 214 comprising two removable parts 236 that are connected via cords 240 to the handle 214. The parts 236 can be detached from the handle 214 and the cords 240 withdrawn from therein to allow the cords 240 to wrap around the scooter 200 and secure a pack 40 thereto, as illustrated in FIG. 22.

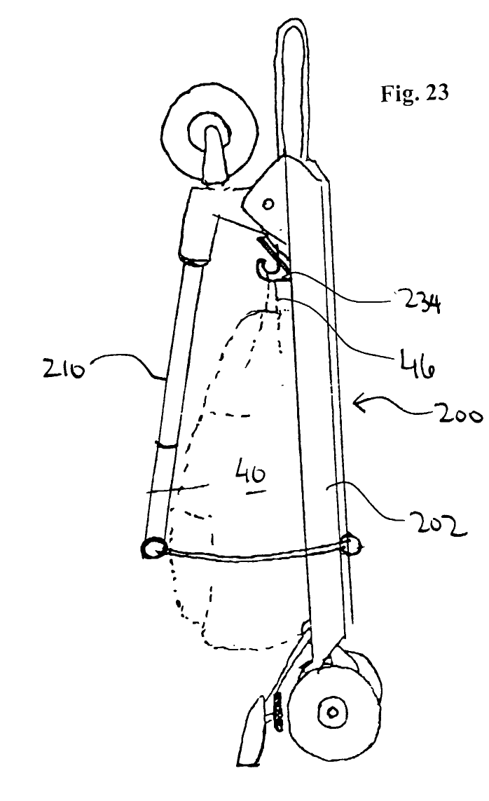

The pack 40 may be secured to either side of the riding surface 202. For example, the pack may be secured to the riding side of the riding surface 202, as illustrated in FIG. 23. In such a configuration, the handle assembly 210 may be used to at least partially secure the pack 40 against the riding surface 202. A hook 234 may also be mounted or formed on the riding surface 202, as illustrated in FIGS. 23-25, to allow the loop 46 of the pack 40 to attach thereover. One or more chords 242 may also be provided recessed within a hollow riding surface 202 for withdrawal to wrap or otherwise secure a pack 40 relative to the scooter 200. The chord 242 may be biased toward a storage position substantially within the riding surface 202.

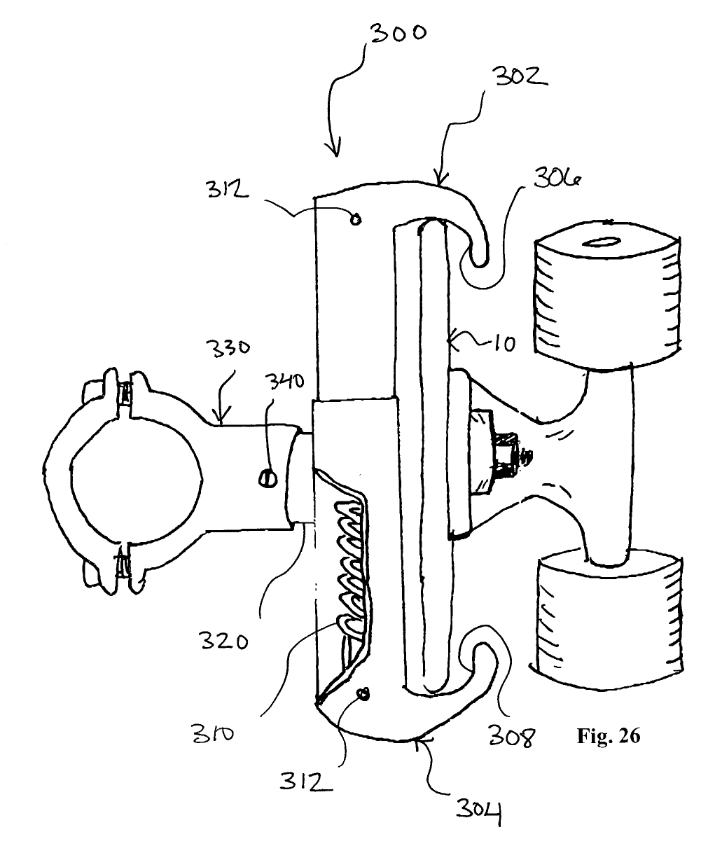

FIGS. 26-29 illustrate a clamping assembly 300 for securing a personal transportation device, such as a skateboard 10, to a vehicle, such as a bicycle 360. The clamping assembly 300 allows for convenient transportation of the personal transportation device.

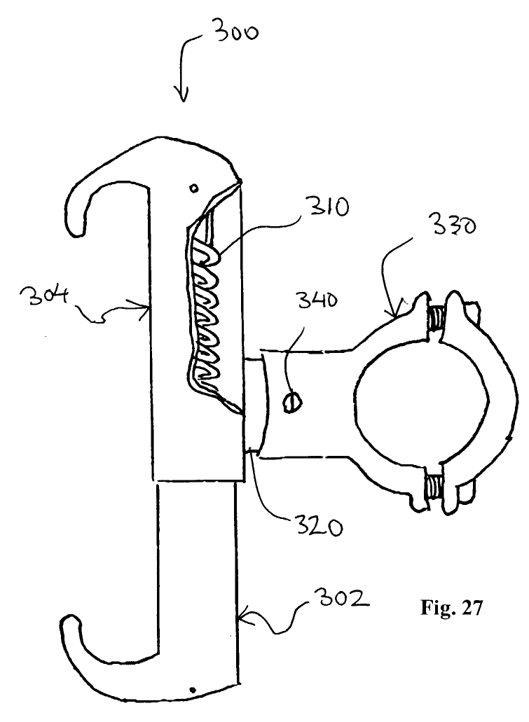

As illustrated in FIG. 27, the clamping assembly 300 comprises a pair of opposing jaw members 302 and 304 having clamping elements 306 and 308 formed thereon. The clamping elements 306 and 308 are urged toward each other by a resilient biasing member, such as a spring 310. The clamping elements 306 and 308 are configured to hold the personal transportation device 10 therebetween under the biasing force of the spring 310.

Turning to more of the details, the jaw members 302 and 304 may be telescopingly slidable relative to each other. The jaw members 302 and 304 may each have hollow regions, allowing for the spring 310 to be housed at least partially within the hollow region of the jaw members 302 and 304. Ends of the spring 310 may have hooks that connect to the jaws 302 and 304 via holes 312 formed therein, although other connections between the jaws 302 and 304 and the spring 310 may also be suitable.

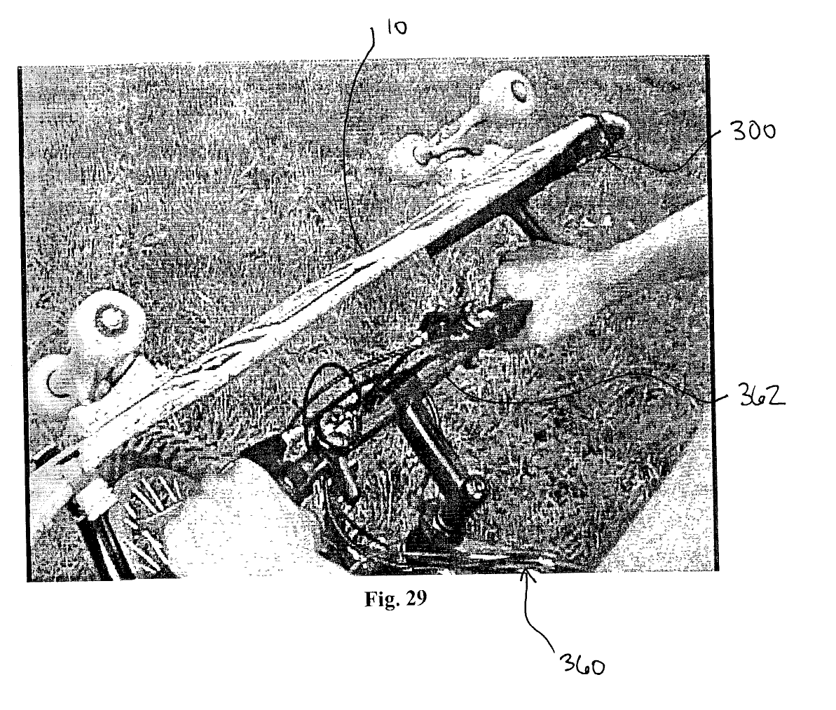

A mounting assembly 320 is connected at one end relative to at least one of the jaws 302 and 304 and at another end to a bracket assembly 330. The bracket assembly 330 can be selectively secured to a portion of the vehicle. For example, if the vehicle comprises a bicycle, as illustrated in FIG. 29, the bracket assembly 330 can be secured to handlebars 362 thereof. The bracket assembly 330 can comprise a clamp having a pair of opposing concave portions that can be clamped around a handlebar 362. While one clamping assembly 300 can be configured for holding the personal transportation device 10, two or more clamping assemblies 300 may also be used. Portions of either the mounting assembly 320, the bracket assembly 330, or both may be configured for use as handle bar extensions.

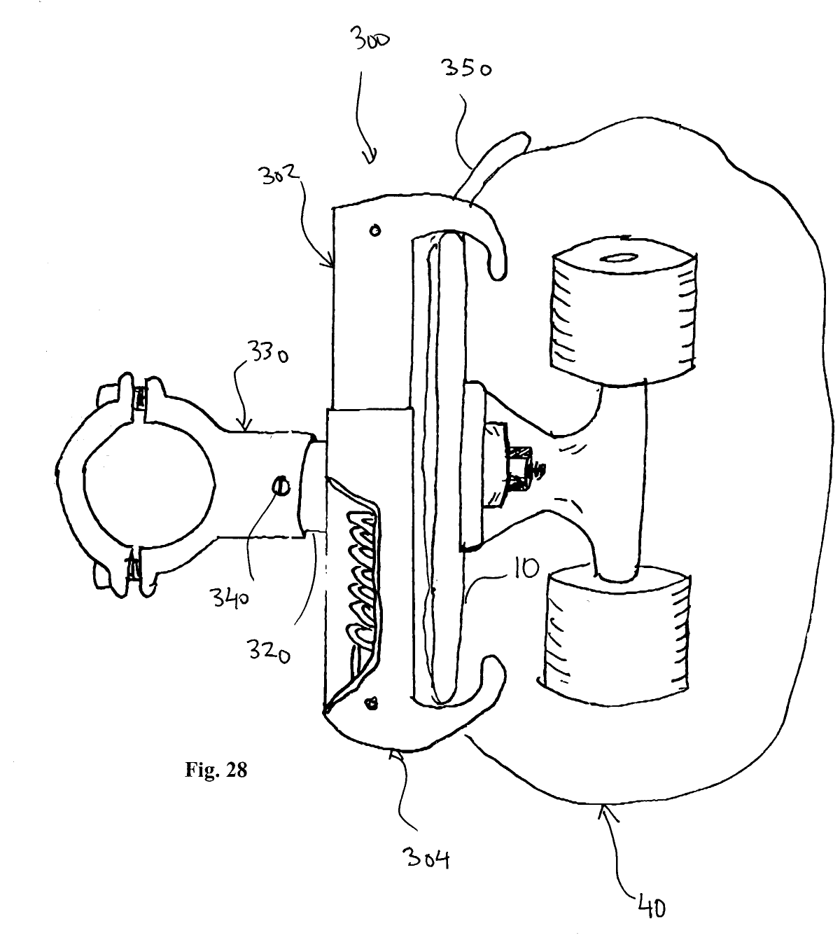

As illustrated in FIG. 26, the personal transportation device 10 can be secured between the jaws 302 and 304 due to the biasing force of the resilient biasing member 310. In addition, grip tape disposed on the personal transportation device 10 can have a coefficient of friction effective to reduce sliding between the jaw members 302 and 304 and the personal transportation device. A pack 40 or other lading may be secured to the personal transportation device 10, as discussed above in greater detail, as illustrated in FIG. 28. When the personal transportation device 10 is held by the clamping assembly 300, the pack 40 or other lading may also be supported for transportation by the vehicle.

When the personal transportation device 10 is secured by the clamping assembly 300, various orientations of the personal transportation device 10 may be desired, such as to reduce interference with operation of the vehicle. To adjust the position of the personal transportation device 10, various angles between the handlebar 362 or other securement portions of the vehicle and the clamping jaws 302 and 304 can be selected to ensure that interference is minimized. When two or more clamping assemblies 300 are utilized, the geometry of the securement portion of the vehicle to which they are secured may require that adjustments in angle and position be made between the securement portion, the mounting assembly 320, and/or the bracket assembly 330. For example, the mounting assembly 320 may be rotatable with respect to the bracket assembly 330. A set screw 340 may be selectively used to allow the assemblies 320 and 330 to rotate and tightened to prevent rotation. Pins and other devices also may be suitable for selectively allowing rotation between the assemblies 320 and 330.

From the foregoing, it will be appreciated that apparatus for transporting both riders and lading and/or the apparatus itself by providing an apparatus convertible between a riding configuration and a lading transporting or apparatus transporting configuration are provided. The invention is not limited to the illustrated aspects discussed herein above, or to any particular aspects. For example, although scooters and skateboards are illustrated in the figures, the invention is not limited to scooters and skateboards.

The invention is defined more particularly by the following claims:

1. A personal transportation apparatus comprising:
a generally planar member having a riding surface and a second surface opposite the riding surface;
a first wheel set and a second wheel set attached relative to the second surface of the member, the first and second wheel sets being positioned to allow for the member to be supported by the wheel sets in a generally horizontal orientation, and the first wheel set positionable relative to the second surface of the member to allow the member to be supported in an orientation generally inclined relative to the horizontal orientation.

2. A personal transportation apparatus according to claim 1, wherein the apparatus comprises a skateboard having the first and second wheel sets positioned to substantially contact a riding surface when the skateboard is in the generally horizontal orientation and the first wheel set positionable for contacting the riding surface when the skateboard is in the generally inclined position.

3. A personal transportation apparatus according to claim 2, wherein a gripping handle is provided on an end of the skateboard opposite the first wheel set.

4. A personal transportation apparatus according to claim 3, wherein in the generally inclined orientation lading having a fastener attached thereto is securable relative to the skateboard by positioning the faster at least partially around the gripping handle.

5. A personal transportation apparatus according to claim 2, wherein the first wheel set is attached to a retraction assembly adapted for moving the first wheel set between a retracted configuration positioned substantially beneath the riding surface of the skateboard in the generally horizontal orientation and an extended configuration having at least a portion of the first wheel set extending beyond an end of the skateboard in the generally inclined orientation.

6. A personal transportation apparatus according to claim 5, wherein the retraction assembly comprises a hinge having a first hinge portion and a second hinge portion pivotably connected about a pivot member, the first hinge portion connected relative to the second surface of the skateboard and the second hinge portion connected relative to the first wheel set.

7. A personal transportation apparatus according to claim 5, wherein the retraction assembly comprises a pivotable connection member effective to allow the first wheel set to rotate about the pivotable connection member relative to the skateboard between the retracted and extended configurations.

8. A personal transportation apparatus according to claim 5, wherein the retraction assembly comprises a track positioned on the second surface of the skateboard and the first wheel set has a track mating portion adapted for translating along the track between the retracted and extended configurations.

9. A personal transportation apparatus according to claim 2, wherein the skateboard comprises a first portion and a second portion pivotable relative to the first portion about a hinge, both of the first and second wheel sets being connected relative to the first skateboard portion, the first wheel set being positioned on the first skateboard portion to protrude at least partially past the hinge.

10. A personal transportation apparatus according to claim 2, wherein the skateboard comprises a first portion and a second portion pivotable relative to the first portion about a hinge, the first wheel set being attached relative to the second skateboard portion and the second wheel set being attached relative to the first skateboard portion, and a support assembly being attached to the second surface of the skateboard for preventing pivoting of the second skateboard portion relative to the first skateboard portion about the hinge toward the second surface of the skateboard while allowing pivoting of the second skateboard portion relative to the first skateboard portion about the hinge toward the riding surface of the skateboard.

11. A personal transportation apparatus according to claim 1, wherein the apparatus comprises a scooter having an upstanding handle assembly pivotably connected to the planar member proximate an end of the scooter having the second wheel set attached thereto, the handle assembly pivotable between an upstanding position having a first angle relative to the planar member and a folded position having a second angle relative to the planar member less than the first angle, the first wheel set being positioned to protrude beyond a second end of the scooter opposite the first end when the scooter is in its inclined position.

12. A personal transportation apparatus according to claim 11, wherein a gripping assembly is provided at the first end of the scooter.

13. A personal transportation apparatus according to claim 12, wherein in the generally inclined orientation lading having a fastener attached thereto is securable relative to the skateboard by positioning the faster at least partially around the gripping assembly.

14. A personal transportation apparatus according to claim 11, wherein the handle assembly includes one or more fastener straps for securing lading relative to the scooter when the scooter is in the inclined orientation.

15. An apparatus for adapting a personal transportation device for transporting the device, the apparatus comprising:
the personal transportation device having a first surface and a second surface, one or more wheels positioned relative to the first surface for supporting the device in a generally horizontal orientation; and
a wheel assembly removably positionable relative to the personal transportation device and having a base with one or more wheels positioned on the base and adapted for rotation relative thereto, on the effective to allow the device to be rolled using the wheel assembly in a positioned inclined relative to the generally horizontal orientation.

16. An apparatus according to claim 15, wherein the device comprises a skateboard having a first end and a second end, and the wheel assembly includes a slot for receiving one of the first and second ends of the skateboard to position the wheel assembly relative to the skateboard.

17. An apparatus according to claim 16, wherein a handle assembly is provided for guiding the device when rolled using the wheel assembly, the handle assembly having a slot for receiving the end of the skateboard opposite the end having the wheel assembly positioned relative thereto.

18. An apparatus according to claim 17, wherein fasteners are provided extending between the wheel and handle assemblies for at least partially securing the wheel and handle assemblies relative to the skateboard.

19. An apparatus according to claim 18, wherein lading may be at least partially secured relative to the skateboard with the fasteners.

20. A clamping assembly for securing a personal transportation device relative to a vehicle, the clamping assembly comprising:
first and second jaw members translatable relative to each other, each of the jaw members having a gripping element on a portion thereof;
a biasing element operatively connected between the first and second jaw members, the biasing mechanism being effective to bias the gripping elements toward each other;
a mounting assembly for securement to a clampable member of the vehicle; and
a bracket assembly connected relative to at least one of the first and second jaw members and the clamping assembly.

21. A clamping assembly in accordance in with claim 20, wherein the personal transportation device comprises a skateboard.

22. A clamping assembly in accordance with claim 21, wherein the vehicle comprises a bicycle and the clampable member comprises a handlebar of the bicycle.
